(19) United States
(12) Patent Application Publication
(10) Pub. No.: US 2026/0331138 A1
(43) Pub. Date: Oct. 22, 2026

(54) HARD DISK DRIVE ENCLOSURES WITHOUT GASKETS

(71) Applicant: SEAGATE TECHNOLOGY LLC, Fremont, CA (US)

(72) Inventors: Patrick Michael Thomas, Lyons, CO (US); Akihiko Ohnaka, Longmont, CO (US); Brian D. Adler, Longmont, CO (US)

(21) Appl. No.: 19/652,161

(22) Filed: Apr. 20, 2026

Related U.S. Application Data
(60) Provisional application No. 63/792,079, filed on Apr. 21, 2025.

(51) Int. Cl. G11B 23/03

(52) U.S. Cl. CPC G11B 23/0321; G11B 23/0326

(57) ABSTRACT

Methods and devices include approaches that utilize a hard disk drive with a base deck having a sidewall and a bottom portion to form an internal cavity. The sidewall includes a rim with a first flat surface extending around a first perimeter of the sidewall. One or more covers are coupled to the base deck to seal the internal cavity. The one or more covers include a process cover coupled to the sidewall of the base deck. The process cover includes a second flat surface directly contacting the first flat surface to create a sealing interface.

### RELATED APPLICATIONS

This application claims priority to U.S. Provisional Patent Application No. 63/792,079, filed April 21, 2025, which is hereby incorporated by reference herein for all purposes.

### SUMMARY

In certain embodiments, a hard disk drive includes a base deck and one or more covers coupled to the base deck for sealing an internal cavity. The base deck includes a sidewall and a bottom portion. The sidewall includes a rim with a first flat surface extending around a first perimeter of the sidewall. The one or more covers includes a process cover coupled to the sidewall of the base deck. The process cover includes a second flat surface directly contacting the first flat surface to create a sealing interface along an entirety of the first perimeter.

In certain embodiments, a method includes coupling a process cover to a base deck to seal an internal cavity. The base deck includes a sidewall with a rim, which has a first flat surface extending around a perimeter of the sidewall. The process cover includes a second flat surface. The method further includes creating a sealing interface by causing the first flat surface to directly contact the second flat surface along an entirety of the perimeter.

### BRIEF DESCRIPTION OF THE DRAWINGS

FIG. 1 shows a cut away side view of a hard disk drive, in accordance with certain embodiments of the present disclosure.

FIG. 2 shows an exploded view of a hard disk drive, in accordance with certain embodiments of the present disclosure.

FIG. 3 shows a perspective view of a bottom side of a cover of the hard disk drive of FIG. 2, in accordance with certain embodiments of the present disclosure.

FIG. 4 shows a side view of a portion of the hard disk drive of FIG. 2, in accordance with certain embodiments of the present disclosure.

FIG. 5 shows an exploded view of a hard disk drive, in accordance with certain embodiments of the present disclosure.

FIG. 6 shows a side view of a portion of the hard disk drive of FIG. 5, in accordance with certain embodiments of the present disclosure.

FIG. 7 shows an exploded view of a hard disk drive, in accordance with certain embodiments of the present disclosure.

FIG. 8 shows a side view of a portion of the hard disk drive of FIG. 7, in accordance with certain embodiments of the present disclosure.

FIG. 9 shows an exploded, perspective view of a cover with a sealed damper, in accordance with certain embodiments of the present disclosure.

FIG. 10 shows an exploded, perspective view of a cover with a sealed damper, in accordance with certain embodiments of the present disclosure.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope of the appended claims.

### DETAILED DESCRIPTION

Certain embodiments of the present disclosure are directed to methods and devices that involve sealing a hard disk drive enclosure without using a gasket material (e.g., gasket materials such as form-in-place-gaskets or FIPGs). One or more covers can be coupled to a base deck to create an enclosure. The enclosure can be sealed without using a gasket material. In certain embodiments, respective surfaces of the cover and base deck that contact each other comprise a continuous flat surface portion around an entire perimeter of the cover and base deck. As such, the hard disk drive includes continuous flat mating surfaces along a perimeter.

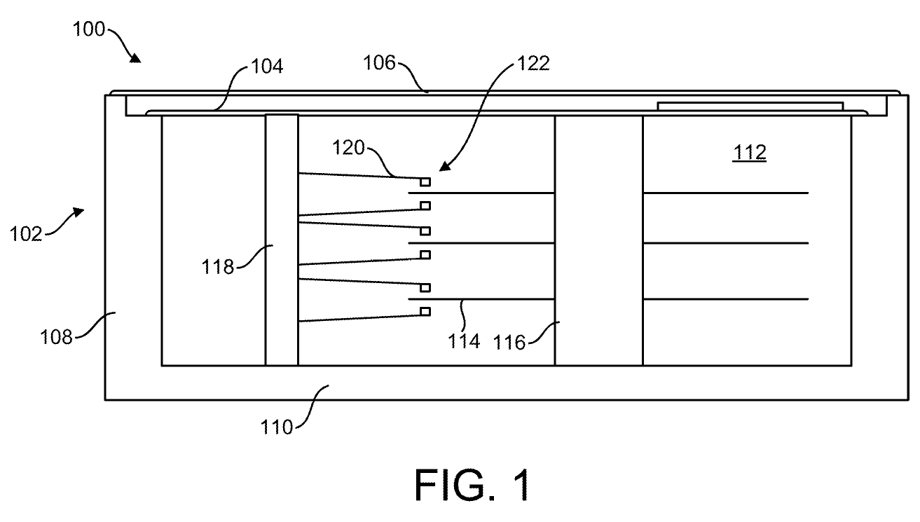

FIG. 1 shows a cut away side view of a hard disk drive 100 including a base deck 102, a process cover 104, and a final cover 106. The base deck 102 includes a sidewall 108 that, together with a bottom portion 110 of the base deck 102 and the process cover 104, create an enclosure with an internal cavity 112. The internal cavity 112 houses data storage components like magnetic recording media 114, a spindle motor 116, an actuator pivot bearing 118, suspensions 120, and read/write heads 122. The spindle motor 116 and the actuator pivot bearing 118 are shown in FIG. 1 as being coupled between the process cover 104 and the bottom portion 110 of the base deck 102.

During assembly, the process cover 104 can be coupled to the base deck 102 by removable fasteners (e.g., screws). Once the process cover 104 is coupled to the base deck 102, a target gas (e.g., air with nitrogen and oxygen and/or a lower-density gas like helium) may be injected into the internal cavity 112 through an aperture in the process cover 104, which is subsequently sealed. Injecting the target gas, such as a combination of air and a low-density gas like helium (e.g., 90 percent or greater helium), may involve first evacuating existing gas from the internal cavity 112 using a vacuum and then injecting the target gas from a low-density gas supply reservoir into the internal cavity 112. The aperture in the process cover 104 can be sealed via an adhesive, weld, or the like to keep the target gas within the hard disk drive 100 and, in particular, the internal cavity 112. The final cover 106 can be coupled to the base deck 102 via welding (e.g., friction stir welding, laser welding).

Traditionally, to help provide a seal, hard disk drives have used a polymer-based FIPG that is positioned between a base and cover. However, FIPGs can outgas materials under certain conditions and impact performance of internal components of hard disk drives. For example, outgassed materials can migrate from the FIPGs and into various areas of the internal cavity of hard disk drives. If the outgassed materials deposit onto the magnetic recording media or the read/write heads, the materials can cause errors and/or failures. For example, the materials may interfere with a hard disk drive’s ability to read data from the magnetic recording media or write data to the magnetic recording media. Further, FIPG materials can absorb oxygen within a sealed enclosure which can negatively affect performance.

The present disclosure describes approaches that, in certain embodiments, eliminate the use of a gasket material, such as a formed‑in‑place gasket (FIPG), to create a sealed enclosure. In the absence of a gasket or adhesive material, the base deck and/or the cover can include smooth mating surfaces. For example, designs that utilize an FIPG typically include cavities or indented regions to accommodate the gasket material, whereas gasket‑less approaches described herein can use continuous flat mating surfaces extending around a perimeter of the cover (e.g., a bottom surface of the cover, a side surface of the cover) and base deck (e.g., a top surface of a wall of the base deck, a side surface of a wall of the base deck). According to some embodiments, one flat mating surface may be formed on a bottom surface and/or side surface of the cover facing the base deck, and a corresponding flat mating surface may be formed on a top surface and/or side surface of a wall or rim of the base deck. Direct metal‑to‑metal contact of these flat mating surfaces (e.g., with no gasket positioned therebetween) provides a continuous sealing interface around a perimeter.

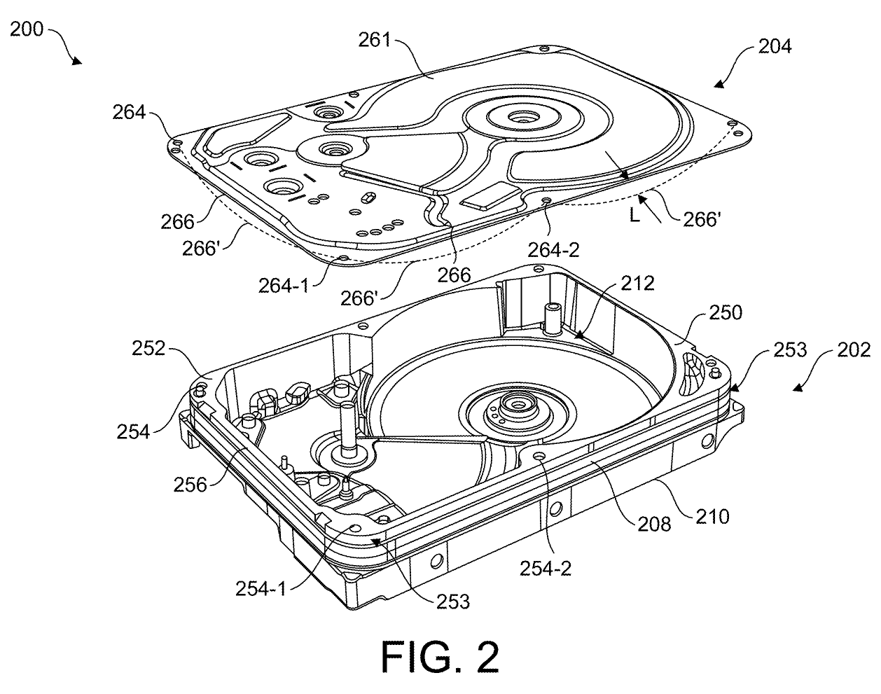

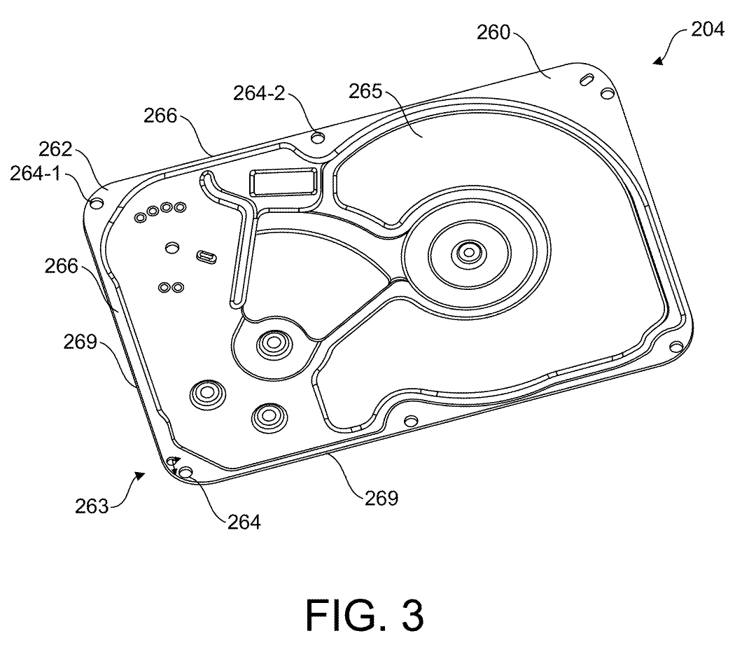

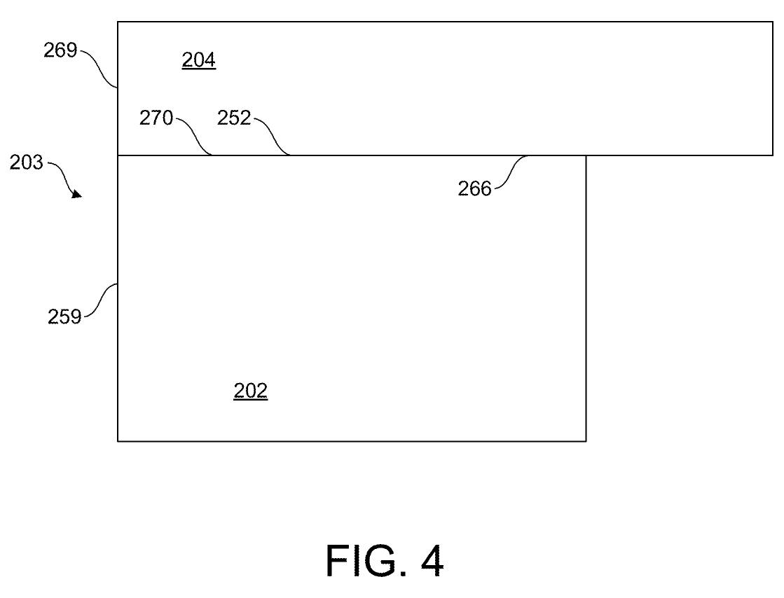

FIG. 2 shows an exploded view of a hard disk drive 200 with a cover 204 and a base deck 202, FIG. 3 shows a perspective view of a bottom of the cover 204 of the hard disk drive 200 of FIG. 2, and FIG. 4 shows a side view of a portion of the cover 204 and the base deck 202 along an outer perimeter 203 of the hard disk drive 200, according to some embodiments. Both the cover 204 and the base deck 202 include a respective flat surface that is continuous along a perimeter of the cover 204 and base deck 202. When the cover 204 is directly coupled to the base deck 202, the flat surfaces contact each other. One of the flat surfaces is formed on a bottom surface of the cover 204 and another of the flat surfaces is formed on a top surface of a wall or rim of the base deck 202. As such, the respective flat surfaces help reduce the risk of gas from leaking from the interior cavity 212 and particles entering the interior cavity 212.

Referring to FIG. 2 or 3, the base deck 202 and the cover 204 of the hard disk drive 200 are shown prior to assembly, according to some embodiments. The cover 204 has an upper surface 261 and a bottom surface 265. In some embodiments, a damper layer may be coupled to the upper surface 261 of the cover 204. The damper layer can include an outer perimeter coupled to the cover 204 to form a sealed enclosure, and a damping material can be disposed in the sealed enclosure. In some embodiments, the sealed enclosure is enclosed by an enclosure feature (e.g., a weld), which directly couples the damper layer to upper surface 261 of the cover 204. The weld can be created by, for example, laser welding. An example hard disk drive including a process cover is described in U.S. patent application No. 19/560,826, the entirety of which is hereby incorporated by reference. The features (e.g., damping material in a sealed enclosure) of the process cover described in U.S. patent application No. 19/560,826 can be incorporated into any of the process covers described herein.

As illustrated in FIG. 2, the base deck 202 includes a bottom portion 210 and a sidewall 208 that together define an internal cavity 212 for housing disk drive components. A final cover (e.g., such as the final cover 106 in FIG. 1) can be coupled (e.g., welded) to the base deck 202 after coupling (e.g., fastening) the cover 204 to the base deck 202. As shown, the cover 204 is configured to be coupled to the sidewall 208 of the base deck 202 to seal the internal cavity 212 without the use of a gasket or an adhesive material.

The sidewall 208 of the base deck 202 includes a wall or rim 250 that extends along the perimeter of the base deck 202. The rim 250 includes one or more first coupling regions 252 (e.g., screw pad regions), each forming at least one screw hole 254 configured to receive a fastener extending through the through hole 264 of the cover 204. The screw pad regions 252 include a first screw pad region 252‑1 located at a corner portion 253 of the rim 250 and a second screw pad region 252‑2 located between adjacent corner portions 253, and so on. One or more wall or rim regions 256 are formed between and continuously connect the screw pad regions 252.

As shown in FIG. 3, the cover 204 includes an outer perimeter 260 extending along an outer perimeter of the bottom surface (e.g., base-deck-facing surface) of the cover 204. When the cover 204 is assembled to the base deck 202, the outer perimeter 260 of the cover 204 contacts the wall or rim 250 (FIG. 2) formed on the sidewall 208 of the base deck 202. The outer perimeter 260 includes one or more second coupling regions 262 (e.g., screw hole regions), each forming at least one through hole 264 for receiving a fastener. The outer perimeter 260 further includes one or more edge regions 266 that continuously extend along the outer perimeter. In the illustrated embodiment, a first screw hole region 262‑1 is located at a corner portion 263 of the outer perimeter 260, while a second screw hole region 262‑2 is located between adjacent corner portions 263, and so on.

A bottom surface of the cover 204 along the outer perimeter 260 defines a flat surface that is continuous around the perimeter (e.g., the entire perimeter) of the cover 204 and is configured to contact a corresponding flat surface of the base deck 202 when assembled to the base deck 202. As shown in FIG. 3, the flat bottom surface of the outer perimeter 260 is wider around the screw hole regions than other sections of the flat bottom surface. The flat bottom surface of the outer perimeter 260 is shown as completely surrounding other defined features of the cover 204 such as bosses and holes for assembling the cover 204 to the spindle motor, voice coil motor assembly, and pivot bearing.

When the cover 204 is coupled to the base deck 202, the one or more second coupling regions (e.g., screw hole regions 262) of the outer perimeter 260 are aligned with the one or more first coupling regions (e.g., screw pad regions 252) of the rim 250.

FIG. 4 shows a side view of a portion of the cover 204 and the base deck 202 along an outer perimeter 203 of the hard disk drive 200 when the cover 204 is positioned on the base deck 202. Flat surfaces of the cover 204 and the base deck 202 contact each other to form a continuous metal‑to‑metal sealing interface 270 extending around the outer perimeter 203 of the hard disk drive 200. The sealing interface 270 can seal the internal cavity without requiring use of a gasket.

Referring back to FIG. 2, in some embodiments, prior to assembly, one or more of the edge regions 266 of the outer perimeter 260 located between adjacent through holes 264‑1 and 264‑2 can be formed with a pre‑bow configuration 266’ including a slight downward curvature toward the base deck 202. The pre‑bowed configuration 266’ can be configured such that the edge region 266 is elastically biased toward the rim 250. In some examples, the pre-bowed configuration 266’ may have a downward offset L, measured at a midpoint between adjacent through holes 264‑1 and 264‑2, in the range, for example, about 5 micrometers to about 200 micrometers, about 5 micrometers to about 100 micrometers, or about 5 micrometers to about 50 micrometers. In some examples, the ratio between the downward offset L and the distance between adjacent through holes 264‑1 and 264‑2 may be in the range, for example, about 1:100 to about 20,000, about 1:200 to about 1:10,000, or about 1:500 to about 1:5,000.

Upon coupling the cover 204 to the base deck 202 by, for example, inserting fasteners through the through holes 264-1 and 264-2 and into the corresponding screw holes 254-1 and 254-2 of the screw pad regions 252, the applied clamping force causes the pre‑bowed edge region 266 to elastically deform and substantially flatten. After assembly, the edge region 266 directly contacts the rim region 256 of the rim 250 along its length, thereby maintaining continuous metal‑to‑metal contact between the cover 204 and the base deck 202 and reducing the risk of forming gaps between adjacent fastener locations.

The outer perimeter 260 of the process cover 204 includes a side edge 269 extending around the outer perimeter 260. In certain embodiments, the side edge 269 extends along substantially straight lines between adjacent corner portions 253 and is formed without protrusions, such as tabs, extending outward from the side edge. Traditionally, when a gasket or an adhesive material is positioned between a process cover and a base deck, one or more tabs are provided on the side edge of the process cover to facilitate handling or assembly. According to certain embodiments described herein, such tabs are eliminated from the side edge 269 because sealing can be achieved without a gasket or adhesive material, and the absence of tabs reduces the likelihood of interference or rubbing between the process cover 204 and a final cover (e.g., the final cover 106 in FIG. 1), thereby mitigating particle generation. As shown in FIG. 4, when the process cover 204 is assembled with the base deck 202, the side edge 269 of the process cover is aligned with a side edge 259 of the sidewall 208. For at least some embodiments, in this assembled state, the side edge 269 is free of protrusions along the direction of the sealing interface 270.

In some embodiments, the rim of the sidewall is formed of a first metallic material, and the outer perimeter of the process cover is formed of a second metallic material, where each metallic material may be selected to achieve desired mechanical, thermal, and damping performance characteristics. In certain embodiments, at least one of the first metallic material and the second metallic material can include steel, such as carbon steel or stainless steel. In some embodiments, the contacting rim of the sidewall and the outer perimeter of the process cover can be manufactured from the same material, for example a metallic alloy such as stainless steel, aluminum, or other suitable engineering metals, to simplify manufacturing, improve thermal expansion compatibility between the base deck and the cover, and enhance direct metal‑to‑metal contact at the sealing interface.

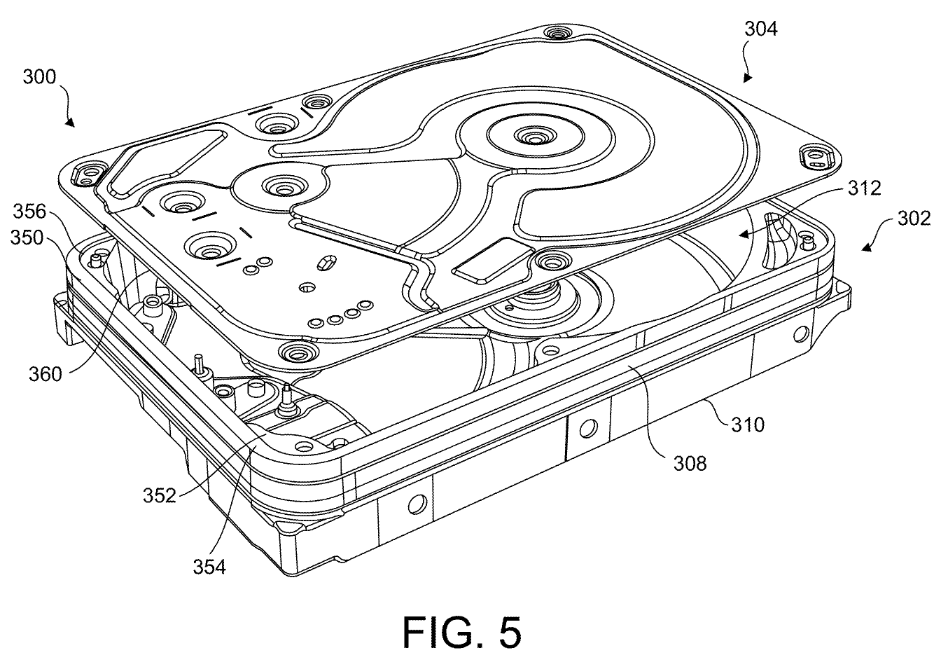

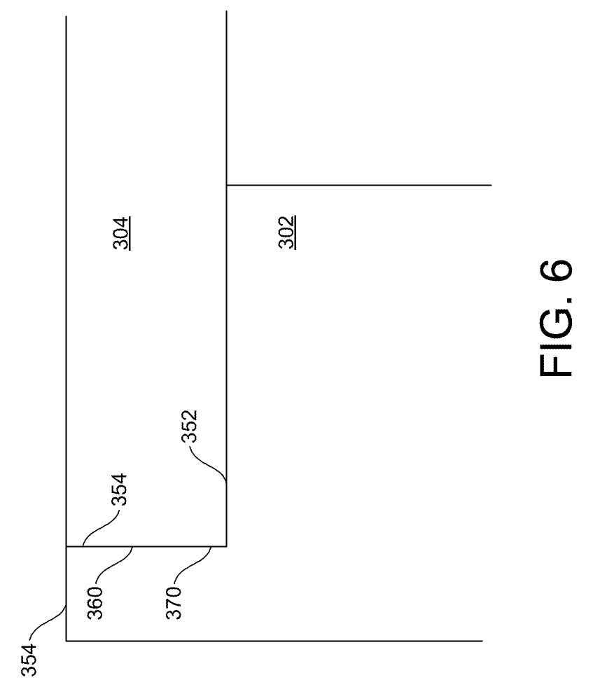

FIG. 5 shows an exploded view of a hard disk drive 300 with a cover 304 and a base deck 302, and FIG. 6 shows a side view of a portion of the cover 304 and the base deck 302 along an outer perimeter of the hard disk drive 300.

The base deck 302 and the cover 304 of the hard disk drive 300 prior to assembly are shown. The base deck 302 includes a bottom portion 310 and a sidewall 308 that together define an internal cavity 312. The sidewall 308 includes a rim 350 extending around an outer perimeter of the hard disk drive 300. As shown, the rim 350 includes one or more screw pad regions, each forming at least one screw hole for receiving a fastener.

As shown in FIG. 5, the base deck 302 includes two top surfaces — a lower top surface 352 and an upper top surface 354. An interior surface 356 of the wall extends between the lower top surface 352 and the upper top surface 354. The interior surface 356 forms a continuous flat surface along a perimeter of the base deck 302.

The cover 304 includes an outer perimeter 360 (e.g., along an outer edge of the cover 304) with a flat surface that, when the cover 304 is assembled to the base deck 302, directly contacts the interior surface 356 of the base deck 302. Before assembly, the cover 304 can be slightly bowed. As the cover 304 is coupled to the base deck 302 (e.g., by using screws), the cover 304 flattens such that the outer perimeter 360 presses against the interior surface 356 of the base deck 302. This decreases the risk that there are gaps between the outer perimeter 360 and the interior surface 356 such that the outer perimeter 360 and the interior surface 356 form a continuous mating surface.

FIG. 6 shows a side view of a portion of the cover 304 and the base deck 302 along the outer perimeter of the hard disk drive 300 in an assembled state. The outer perimeter 360 of the cover 304 directly contacts the interior surface 356 of the base deck 302 to form a sealing interface 370 extending around the perimeter of the cover. As shown in FIG. 6, the height of the interior surface 356 can be the same as the thickness of the cover 304 along the outer perimeter 360 of the cover 304. The sealing interface 370 can be continuous around the entire outer perimeter 360. The sealing interface 370 can seal the internal cavity without requiring use of a gasket.

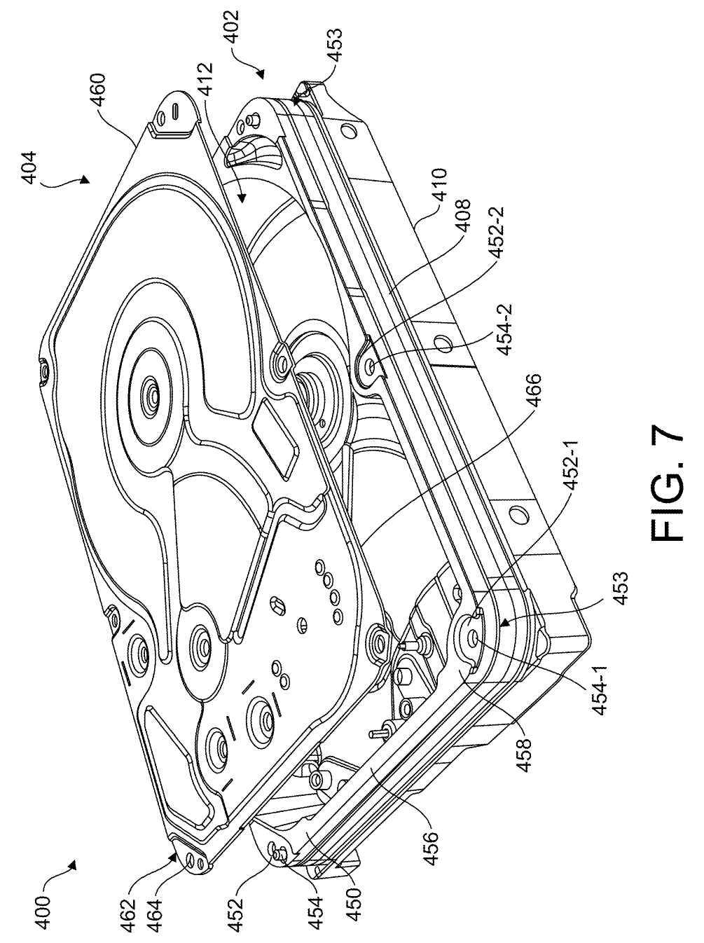

FIG. 7 illustrates an exploded view of a hard disk drive 400, showing a base deck 402 and a cover 404 prior to assembly. The base deck 402 includes a bottom portion 410 and a sidewall 408 that together define an internal cavity 412. The sidewall 408 includes a wall or rim 450 extending along an outer perimeter of the hard disk drive 400. The rim 450 includes one or more screw pad regions 452, each forming at least one screw hole 454, and one or more rim regions 456 extending therebetween. In the illustrated embodiment, a first screw pad region 452‑1 is located at a corner 453 of the rim 450, while a second screw pad region 452‑2 is located between two corners 453, and so on. The cover 404 includes an outer perimeter 460 configured to engage the rim 450 to seal the internal cavity 412 without the use of a gasket or an adhesive material.

The outer perimeter 460 of the cover 404 includes one or more screw hole regions 462, each forming at least one through hole 464. The outer perimeter 460 further includes one or more edge regions 466 that continuously extend along an outer perimeter of the hard disk drive 400. The screw hole regions 462 of the cover 404 are aligned with the screw pad regions 452 of the contacting rim 450 to receive fasteners during assembly.

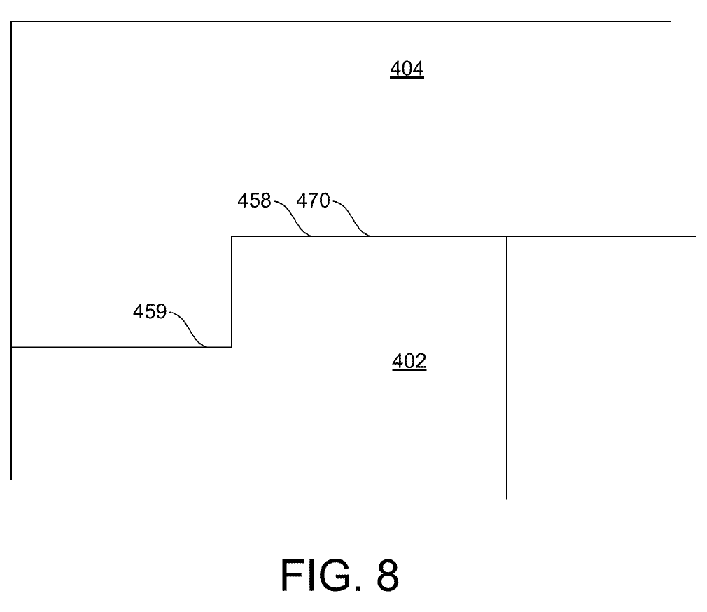

FIG. 8 shows a side view of a portion of the cover 404 and the base deck 402 along the outer perimeter of the hard disk drive 400 when assembled. As shown, the rim 450 of the base deck 402 includes two top surfaces, including an upper top surface 458 and a lower top surface 459. One or both of the top surfaces may include flat surfaces that extend along the perimeter of the base deck 402. In certain embodiments, the lower top surface 459 includes features such as screw holes and locating pins or fiducials, and the flat surface on the lower top surface 459 is positioned closer to the outer perimeter of the hard disk drive 400 than the screw holes.

In the illustrated embodiment, the upper top surface 458 of the rim 450 forms a continuous flat surface around an entire perimeter. Once assembled, the upper top surface 458 directly contacts the outer perimeter 460 (e.g., a flat bottom surface) of the cover 404 to form a continuous metal‑to‑metal sealing interface 470 extending around the perimeter of the hard disk drive 400. During fastening, the cover 404 is drawn toward the screw pad regions 452, causing the cover 404 to provide sealing pressure along the sealing interface 470.

In certain embodiments, the lower top surface 459 of the base deck 402 is formed by discrete lower top surfaces positioned only at the corners 453 of the base deck 402, while the upper top surface 458 forms the only continuous flat surface along the perimeter of the base deck 402. In such embodiments, the cover 404 includes corresponding bottom surfaces configured to mate with the respective upper and lower top surfaces of the base deck 402.

Various methods can be used to manufacture the hard disk drives described herein. For example, a method can include coupling a process cover to a base deck to seal an internal cavity. The method can further include creating a sealing interface by causing the first flat surface to directly contact the second flat surface along an entirety of the perimeter. As described herein, the sealing interface can seal the internal cavity without using a gasket or adhesive. The method can further includes applying a force to cause pre-bowed regions of the process cover to flatten and contact the first flat surface of the base deck.

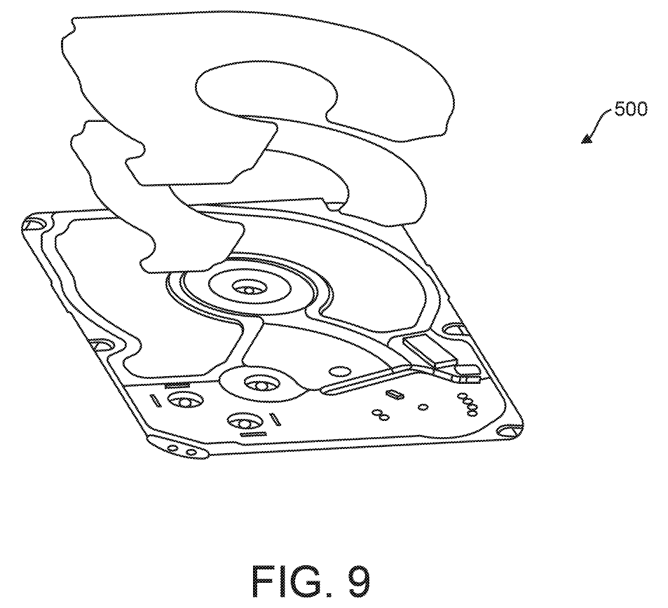

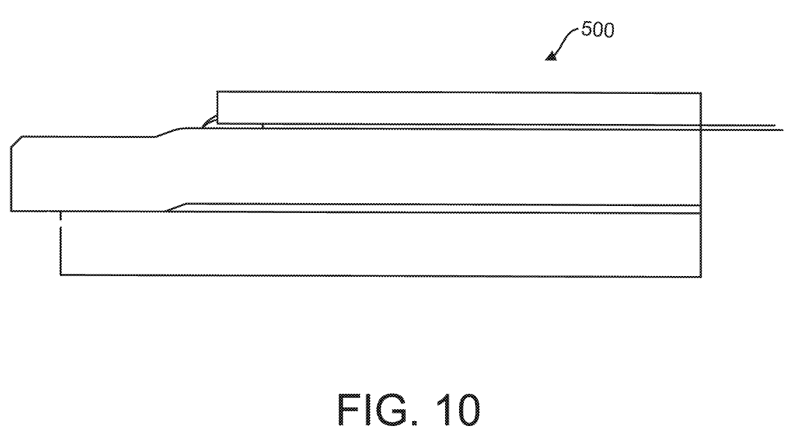

FIGS. 9 and 10 show a process cover 500 with a cover plate (lowest layer), a damper layer (top layer), and a damping material (middle layer) sealed by the damper layer. The damping material is positioned in a sealed enclosure enclosed by a weld (e.g., an enclosed perimeter). The enclosed perimeter can help seal the damping material such as a pressure sensitive adhesive. Because damping materials can outgas (and generate unwanted particles), sealing the damping material can reduce contamination due to outgassing. The various layers of the process cover 500 shown in FIGS. 9 and 10 can be incorporated into any of the covers described herein. The damping material can include one or more viscoelastic polymer layers such as, for example, a PSA layer, an acrylic viscoelastic layer, a butyl‑rubber‑based damping layer, a polyurethane viscoelastic layer, a silicone‑based viscoelastic layer, or a combination thereof. In some examples, the damping material can include a thermoplastic damping layer, a foam-based damping layer, an epoxy-based damping layer, a metal-based damping insert, a composite damping material, or a combination thereof.

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features. Accordingly, the scope of the present disclosure is intended to include all such alternatives, modifications, and variations as falling within the scope of the claims, together with all equivalents thereof.

We claim:

1. A hard disk drive comprising:
a base deck including a sidewall and a bottom portion to form an internal cavity, wherein the sidewall includes a rim with a first flat surface extending around a first perimeter of the sidewall; and
one or more covers for sealing the internal cavity, the one or more covers including a process cover coupled to the sidewall of the base deck, wherein the process cover includes a second flat surface directly contacting the first flat surface to create a sealing interface along an entirety of the first perimeter.

2. The hard disk drive of claim 1, wherein the process cover is coupled to the sidewall of the base deck without using a gasket or an adhesive material.

3. The hard disk drive of claim 1, wherein the sealing interface includes a metal‑to‑metal sealing interface.

4. The hard disk drive of claim 1, wherein the outer perimeter of the process cover includes a side edge extending between adjacent corners of the process cover.

5. The hard disk drive of claim 4, wherein the side edge is free of protrusions along an entire perimeter of the process cover.

6. The hard disk drive of claim 1, wherein the one or more covers further includes a final cover coupled to the base deck.

7. The hard disk drive of claim 1, wherein the outer perimeter of the process cover has a first height, wherein the rim incudes an upper top surface and a lower top surface, wherein a distance between the upper top surface and the lower top surface is the same as the first height.

8. The hard disk drive of claim 1, wherein the first flat surface is an uppermost top surface of the rim.

9. The hard disk drive of claim 8, wherein the second flat surface is a bottom surface of the process cover.

10. The hard disk drive of claim 1, wherein the first flat surface is an interior-facing surface of the rim.

11. The hard disk drive of claim 10, wherein the interior-facing surface extends between an upper top surface and a lower top surface of the rim.

12. The hard disk drive of claim 11, wherein the second flat surface is an outer edge of the process cover.

13. The hard disk drive of claim 1, wherein the process cover includes pre-bowed sections that apply pressure against the rim.

14. The hard disk drive of claim 13, wherein the pre-bowed sections are positioned between openings along second flat surface.

15. The hard disk drive of claim 1, wherein the second flat surface extends around an entirety of the process cover.

16. The hard disk drive of claim 1, wherein the process cover includes a damper layer and a damping material sealed by the damper layer.

17. The hard disk drive of claim 16, wherein the damping material is positioned in a sealed enclosure enclosed by a weld.

18. A method comprising:
coupling a process cover to a base deck to seal an internal cavity, wherein the base deck includes a sidewall with a rim having a first flat surface extending around a perimeter of the sidewall, wherein the process cover includes a second flat surface; and
creating a sealing interface by causing the first flat surface to directly contact the second flat surface along an entirety of the perimeter.

19. The method of claim 18, wherein the sealing interface seals the internal cavity without using a gasket or adhesive.

20. The method of claim 19, wherein the process cover includes a pre-bowed region along the outer perimeter, the method further comprising applying a force to cause the pre-bowed region to flatten and contact the first flat surface.
